(19) United States
(12) Patent Application Publication
(10) Pub. No.: US 2019/0351575 A1
(43) Pub. Date: Nov. 21, 2019

(54) Method for Casting a Construction Element and a Mould for Use in the Method

(71) Applicant: Immensa Technology Labs FZ-LLC, Dubai (AE)

(72) Inventors: Edem Kwabla Dugbenoo, Dubai (AE); Elias Georges Eldik, Dubai (AE)

(21) Appl. No.: 16/415,139

(22) Filed: May 17, 2019

(30) Foreign Application Priority Data
May 17, 2018 (AE) P6000683/2018

(51) Int. Cl. B28B 1/14; B29C 64/106; B28B 7/36; B28B 7/34

(52) U.S. Cl. CPC B28B 1/14; B29C 64/106; B33Y 10/00; B28B 7/346; B28B 7/362

(57) ABSTRACT

A method for casting a construction element includes: using a CAD technique designing mould bodies 12 comprising mould-halves 12.1, 12.2, 12.3, 12.4, 12.5, 12.6, 12.7, 12.8; printing the mould-halves on a 3D printer which includes an adhesive dispensing system; providing a locating formation 16 on mould-half 12.7; reinforcing the mould-halves with two polyurethane or polyurea coatings; applying form wax to the mould-halves; printing a conduit 18 on a 3D printer; locating the mould-halves at a construction site and securing the mould halves to one another; locating the conduit 18 relative to the mould-halves by means of the locating formation 16; pouring concrete into the assembled mould so as to embed the conduit 18 within the concrete; and allowing the concrete to cure; removing the mould-halves and repeating a desired number of times.

### CROSS-REFERENCE TO RELATED APPLICATIONS

This application claims the benefit of priority under 35 U.S.C. § 119 to United Arab Emirates patent application UAE P6000683/2018, tiled on May 17, 2018, the disclosure of which is incorporated herein by reference in its entirety.

### BACKGROUND OF THE INVENTION

### 1. Field of the Invention

This invention relates to a method for casting a construction element and to a mould for use in the method.

### 2. Discussion of Related Art

The use of moulds for casting construction elements are generally well known. Known moulds are typically constructed from sheet material, such as, for example wooden boards or steel sheeting.

One major drawback with conventional methods of producing moulds, is that, due to the complexity and intricate design, it is not always possible to produce moulds for casting construction elements having intricate and or complex shapes. Another major drawback with conventional methods of producing moulds, is that, due to the complexity and intricate design, it is not always cost effective to produce moulds for casting construction elements having intricate and or complex shapes. It will be appreciated that, using known methods for making moulds, as the intricacy and complexity increases, it becomes more and more labour intensive to produce moulds having increased intricacy and complexity. It is therefore very time consuming and therefore expensive to use conventional methods of manufacturing moulds for casting construction elements having intricate and or complex shapes.

It is also necessary to reinforce moulds made using conventional methods, particularly, if it is desired to reuse the moulds. Reinforcing of moulds produced using conventional methods is also time consuming and therefore disadvantageous.

### SUMMARY OF INVENTION

According to a first aspect of the invention there is provided a method for casting a construction element, the method including:
using, at least in part, an additive manufacturing technique to fabricate at least one mould comprising a negative of a construction element to be cast, the at least one mould including one or more casting surfaces;
reinforcing, at least in part, said at least one mould with a polymeric material;
pouring a settable material in contact with said one or more casting surfaces of the at least one mould;
at least partially curing the poured settable material so as to form the construction element.

The construction element may form part of a building structure, such as, for example, a wall or a building.

Reinforcing, at least in part, said at least one mould may, more particularly, comprise coating the at least one mould with the polymeric material. A thickness of the coating of polymeric material may be between 1 mm and 5 mm thick. The polymeric material may be in the form of a plastics material. More particularly, the polymeric material may be in the form of a polyurea based compound or polyurethane.

In a particular embodiment, the method may further include using, at least in part, an additive manufacturing technique to fabricate at least one conduit. The method further including locating the at least one conduit relative to said at least one mould, prior to pouring the settable material. In a particular embodiment, the method may further include providing the mould with a locating formation for locating the at least one conduit relative to the mould and thereby locating the at least one conduit relative to the construction element. The at least one conduit may be configured for receiving one or more cables such as, for example, electrical power cables, telephone cables, data carrying cables and the like. As such, said at least one conduit may have a profile which matches a profile of the construction element. The at least one conduit may be located relative to the mould such that the conduit is at least partially surrounded by the construction element once the construction element is formed. More particularly, the at least one conduit may be embedded in the construction element.

The method may further include removing the at least one mould after thrilling the construction element. The method may further include re-using the removed at least one mould in a method, in accordance with the first aspect of the invention, for casting a construction element.

The method may further include, before pouring the settable material, locating said at least one mould relative to a constructions site at which it is desired to cast the construction element.

The additive manufacturing technique may be in the form of a layer additive manufacturing technique. More specifically, the additive manufacturing technique may be in the form of a three-dimensional (3D) printing technique. The 3D printing technique may include an adhesive dispensing system for dispensing adhesive, onto the article being printed for enhancing the strength and rigidity of the article being printed. As such, said at least one mould may be fabricated from a plastics material. Alternatively, or additionally, the at least one conduit may be fabricated from a plastics material. The use of the adhesive dispensing system particularly enables the additive manufacturing of the mould-halves in a flexible plastic material. It also improves the strength and rigidity of naturally rigid plastic materials

Advantageously, said at least one mould may be rendered re-usable due to the combination of the following steps:
(a) printing said at least one mould using the 3D printing technique including an adhesive dispensing system; and
(b) reinforcing, at least in part, said at least one mould with a polymeric material.

The method may further include, before pouring the settable material, applying a mould releasing material to at least a part of the casting surfaces. More particularly, applying the mould releasing material to at least a part of the casting surfaces may comprise applying at least one coat of form wax. More specifically, applying at least one coat of form wax may comprise applying a first coat of form wax, allowing the first coat of form wax to at least partially dry and thereafter applying a second coat of form wax. More specifically, the first coat of form wax may be allowed to dry for about twenty minutes before applying the second coat of form wax.

The at least one mould may comprise one or more pairs of complementary mould-parts. Each pair of complementary mould-parts may be in the form of a pair of mould-halves. As such the method may include locating each pair of mould-halves relative to one another before pouring the settable material. The method may further include securing the mould-halves to one another. The mould-halves may be secured to one another by means of an adhesive. The adhesive may be in the form of a silicone sealant.

At least partially curing the poured settable material so as to form the construction element may comprise allowing the poured settable material to cure for at least a day. The settable material may be in the form of concrete.

According to a second aspect of the invention there is provided a mould for casting a construction element from settable material, the mould including:
at least one mould body formed, at least in part, by an additive manufacturing technique and comprising a negative of a construction element to be cast, the at least one mould body including one or more casting surfaces; and
a polymeric material for reinforcing the mould body.

The at least one mould body may include a locating formation for locating at least one conduit relative to the mould. The at least one conduit may be configured for receiving one or more cables such as, for example, electrical power cables, telephone cables, data carrying cables and the like.

The additive manufacturing technique may be in the form of a layer additive manufacturing technique. More specifically, the additive manufacturing technique may be in the form of a three-dimensional (3D) printing technique. The 3D printing technique may include an adhesive dispensing system for dispensing adhesive onto the article being printed for enhancing the strength and rigidity of the article being printed. As such, said at least one mould may be fabricated from a plastics material.

The polymeric material may be applied to the mould body. The polymeric material may be in the form of a plastics material. More particularly, the polymeric material may be in the form of a polyurea based compound or polyurethane. The polymeric material may be applied as a coating layer applied to the at least one mould body. A thickness of the coating of polymeric material may be between 1 mm and 5 mm thick.

Advantageously, said at least one mould body may be rendered re-usable due to a combination of a first feature and a second feature, wherein the first feature is that said at least one mould is printed using a 3D printing technique including an adhesive dispensing system; and wherein the second feature is the polymeric material for reinforcing the mould body.

The at least one mould body may comprise one or more pairs of complementary mould-parts. Each pair of complementary mould-parts may be in the form of a pair of mould-halves.

According to a third aspect of the invention there is provided a casting system for casting a construction element from settable material, the casting system including:
at least one mould body formed, at least in part, by an additive manufacturing technique and comprising a negative of a construction element to be cast, the at least one mould body including one or more casting surfaces;
a polymeric material for reinforcing said at least one mould body; and
at least one conduit formed, at least in part, by an additive manufacturing technique.

Said at least one mould body may include a locating formation for locating said at least one conduit relative to the mould body.

The at least one conduit may be configured for receiving one or more cables such as, for example, electrical power cables, telephone cables, data carrying cables and the like.

The additive manufacturing technique may be in the form of a layer additive manufacturing technique. More specifically, the additive manufacturing technique may be in the form of a three-dimensional (3D) printing technique. The 3D printing technique may include an adhesive dispensing system for dispensing adhesive onto the article being printed for enhancing the strength and rigidity of the article being printed. As such, said at least one mould may be fabricated from a plastics material. Said at least one conduit may be of a plastics material.

The polymeric material may be in the form of a plastics material. More particularly, the polymeric material may be in the form of a polyurea based compound or polyurethane. The polymeric material may be applied as a coating layer applied to the at least one mould body. A thickness of the coating of polymeric material may be between 1 mm and 5 mm thick.

The at least one mould body may comprise one or more pairs of complementary mould-parts. Each pair of complementary mould-parts may be in the form of a pair of mould-halves.

The invention extends also to a construction element formed by the method and/or the mould and/or the casting system, as described and defined hereinabove. The invention extends further to a building structure including the construction element formed by the method and/or the mould and/or the casting system, as described and defined hereinabove.

### BRIEF DESCRIPTION OF DRAWINGS

Further features of the invention are described hereinafter by way of a non-limiting example of the invention, with reference to and as illustrated in the accompanying diagrammatic drawings. In the drawings:

FIG. 1 shows a perspective view of a mould, in accordance with the invention, being assembled and illustrates steps in a method, in accordance with the invention, for casting a construction element;

FIG. 2 shows a perspective enlarged view of a mould-half of the mould of FIG. 1;

FIG. 3 shows a perspective view of the assembled mould of FIG. 1 and shows further steps in the method of FIG. 1;

FIG. 4 shows the assembled mould of FIG. 3, showing a settable material curing within the mould;

FIG. 5 shows the mould of FIG. 4 removed to reveal a construction element cast using the mould and method, in accordance with the invention;

FIG. 6A shows a perspective view of another embodiment of a mould and method in accordance with the invention;

FIG. 6B shows a side view of the mould of FIG. 6A; and

FIG. 7 shows a flowchart illustrating the steps in a method in accordance with the invention for casting a construction element.

### DETAILED DESCRIPTION

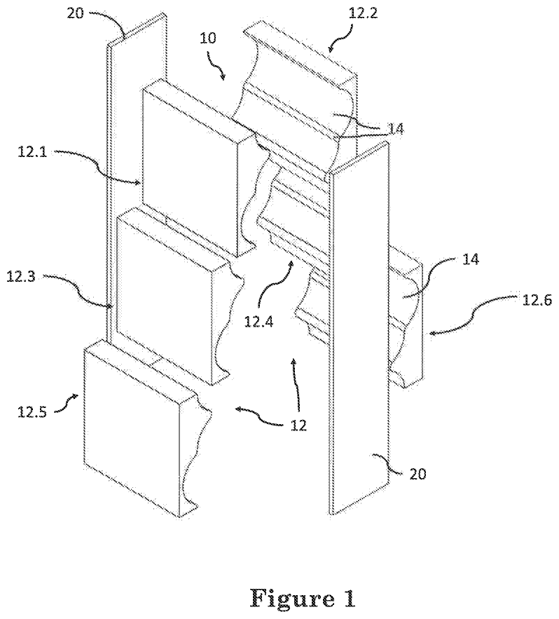

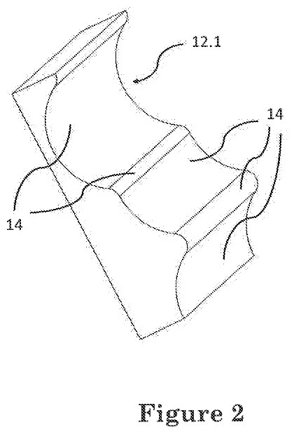

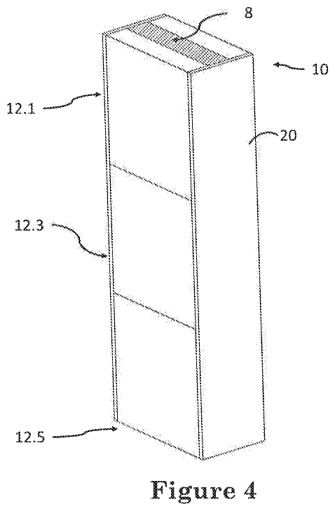

With reference to FIGS. 1 to 5 of the drawings, a mould, in accordance with the invention, for casting a construction element 6 from settable material 8, is indicated generally by the reference numeral 10. The settable material 8 can be any suitable type of material for building, such as, for example, concrete.

The mould 10 includes a number of mould bodies 12 in the form of complementary mould-halves 12.1, 12.2, 12.3, 12.4, 12.5, and 12.6, the mould 10 further includes a polymeric material (not shown) applied to each mould-halves for reinforcing each mould-half.

Each mould-half is formed by an additive manufacturing technique and comprises a negative of a construction element to be cast. The additive manufacturing technique is, more particularly, in the form of a layer additive manufacturing technique, such as, for example, a three-dimensional (3D) printing technique. The 3D printing technique includes an adhesive dispensing system for dispensing an adhesive onto the article being printed for enhancing the strength and rigidity of the article. As such, each mould-half is fabricated from a plastics material. Although any suitable 3D printer may be used, examples of suitable 3D printers include so-called “Fused Filament Fabrication” (FFF) printers which include such brands as Ultimaker™, Extreme Builder™, BigRep™, among many others.

Each mould-half includes one or more casting surfaces 14.

The polymeric material which is applied to each mould-half, is, more particularly, in the form of a plastics material. More specifically, the polymeric material is in the form of polyurethane or a polyurea based compound. The polymeric material is applied as a coating layer applied to each mould-half. More specifically, a thickness of the polymeric material layer is between 1 mm and 5 mm thick.

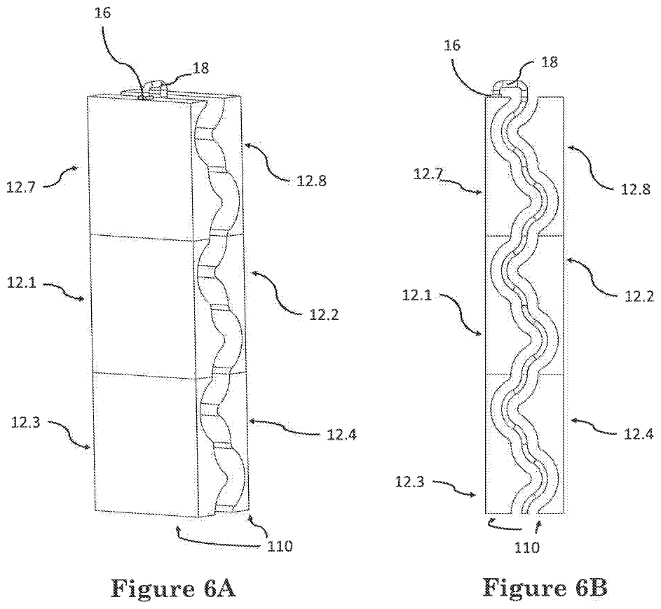

With reference to FIGS. 6A and 6B of the drawings, another embodiment of a mould, in accordance with the invention, for casting a construction element from settable material 8, is indicated generally by the reference numeral 110.

There are many similarities between the mould 10 of FIGS. 1 to 5 of the drawings and the mould 110 of FIGS. 6A & 6B of the drawings. In FIGS. 6A and 6B of the drawings, the features of the mould 110 which are the same and/or similar to features of the mould 10 shown in FIGS. 1 to 5 of the drawings, are designated by the same and/or similar reference numerals in FIGS. 6A and 6B of the drawings. What is stated above with respect to the mould 10 of FIGS. 1 to 5 applies generally to the mould 110 of FIGS. 6A & 6B of the drawings.

The mould 110 of FIGS. 6A & 68 of the drawings is identical to the mould 10 of FIGS. 1 to 5 of the drawings, except that the mould 110 includes mould-halves 12.7, 12.8 which are virtually identical to mould-halves 12.1, 12.2, but differ only in that mould-half 12.7 includes a locating formation 16 for locating a conduit 18 relative to the mould 110 as will be explained in more detail hereinbelow.

The locating formation 16 defines an opening through which an end of the conduit 18 is received, in use, for positively locating the conduit 18 with respect to the locating formation 16. More specifically a connection between the end of the conduit 18 and the locating formation 16 is a tight interference fit for positively locating the conduit 18 with respect to the mould half 12.7 and thereby relative to the mould 110.

The conduit 18 is configured for receiving one or more cables (not shown) such as, for example, electrical power cables, telephone cables, data carrying cables and the like. The conduit 18 is also fabricated from a plastics material by a process of additive manufacturing, more specifically, 3D printing.

The invention extends also to a casting system for casting a construction element from settable material, the casting system including the mould 10, 110 and one or more conduits 18.

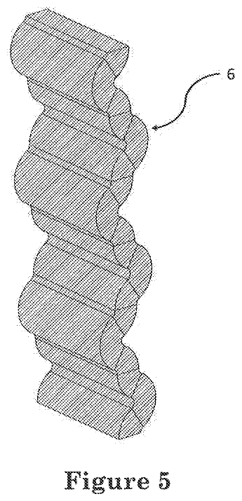

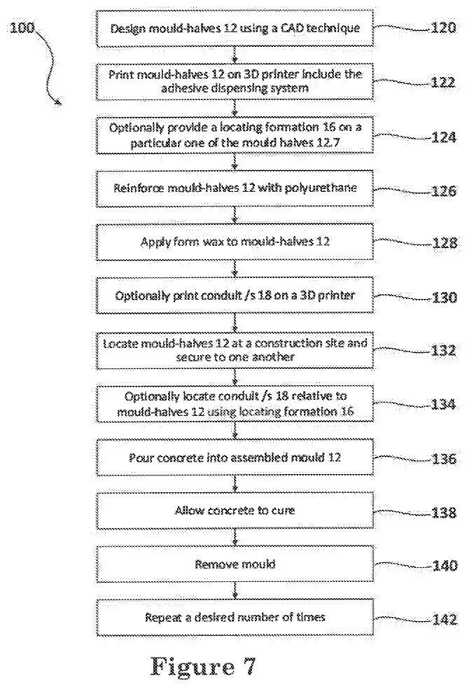

With reference to FIGS. 1 to 7 of the drawings, a method in accordance with the invention, for casting a construction element is indicated generally by the reference numeral 100. The method 100 will be explained in more detail hereinbelow with reference to the production of the mould 10 and/or 110, the mould-halves and the construction element 6 illustrated in FIG. 5 of the drawings.

The first step 120 in the method 100 is to design a mould 10 using computer aided design techniques to produce a computer aided design (CAD) file which can be printed on a printer, such as, for example a 3D printer.

In a second step, 122, using, at least in part, an additive manufacturing technique, the mould 10 is printed on the 3D printer which includes the adhesive dispensing system for dispensing adhesive onto the mould 10 being printed for enhancing the strength and rigidity of the mould 10. Although any suitable 3D printer may be used, examples of a suitable 3D printers include Fused Filament Fabrication (FFF) printers which include such brands as Ultimaker™, Extreme Builder™, BigRep™, among many others.

It will be understood that the mould in accordance with the invention can comprise only one mould body (not shown). Alternatively, the mould 10, 110 can comprise two or more complementary mould-parts, as shown in FIGS. 1 and 6, wherein the mould 10, 110 is in the form of a number of pairs of mould-halves. Each mould-half is a negative of a construction element to be cast and each includes one or more casting surfaces 14. It will be understood therefore that a desired number of pairs of mould-halves can be produced using the 3D printer. It will also be understood that other additive manufacturing techniques may be used to fabricate the mould-halves from a plastics material.

A third step 124 is optional and will be explained in more detail hereinbelow.

After 3D printing the mould-halves, in a fourth step 126, the mould-halves are reinforced, at least in part, with a polymeric material. More particularly, the mould-halves are reinforced by coating the mould-halves with the polymeric material, for example, a polyurea based compound or polyurethane. More specifically, a thickness of the coating of the polymeric material is between 1 mm and 5 mm thick.

The inventors have surprisingly found that the polymeric material significantly enhances the strength of the mould-halves and renders the mould-halves re-usable. More particularly, the inventors have found that by additively manufacturing the mould-halves using the adhesive dispenser system described above, it is possible to use the polyurea polyurethane coatings to significantly improve the strength of both flexible and rigid plastics as well as make them reusable.

In a fifth step 128, a mould releasing material, such as, for example, a form wax is then applied to the casting surfaces 14 of the mould-halves. More particularly, a first coat of form wax is applied to the casting surfaces 14 and allowed to dry for about twenty minutes. Once dried, a second coat of form wax is applied over the first coat.

A sixth step 130 is optional and will be explained in more detail hereinbelow.

As illustrated in FIGS. 1 and 6 of the drawings, in a seventh step 132, the mould-halves are then located at a constructions site at which it is desired to cast the construction element. The mould-halves are arranged in their complementary pairs with casting surfaces 14 of the complementary pairs of mould-halves facing one another. The complementary pairs of mould-halves are then stacked on top of one another as shown in FIGS. 1 and 6 of the drawings. The mould-halves are then secured to one another by any securing means, such as, for example, by means of an adhesive, such as, for example, a silicone sealant for securing the mould-halves to one another. Shuttering material, such as, for example, wooden shuttering boards 20 are then used to support opposite sides of the assembled mould-halves. Any gaps are then sealed with a suitable sealant such as, for example, silicone.

An eighth step 134 is optional and will be explained in more detail hereinbelow.

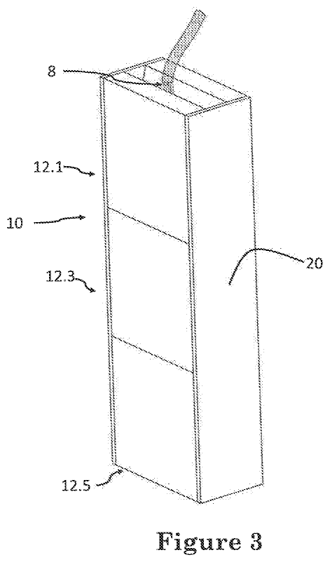

In a ninth step 136 settable material 8 such as, for example, concrete of a desired slump flow is then poured into the assembled moulds as illustrated in FIG. 3 of the drawings so as to bring the concrete into contact with the casting surfaces 14 of the mould-halves.

In a tenth step 138, the concrete is allowed to cure for at least one day.

In an eleventh step 140, once the concrete has sufficiently cured, the mould-halves are then removed to reveal the formed construction element 6, as illustrated in FIG. 5. The form wax facilitates easy demoulding of the mould-halves. It will be appreciated that once removed, the mould-halves can be re-used to cast another concrete construction element, particularly, because the polyurea based compound or polyurethane reinforcement significantly enhances the strength of the mould-halves so as to render the mould-halves re-usable.

In a twelfth step 142, the process is repeated a desired number of times. In particular, it will be appreciated that the mould-halves can be located upon a previously cast building element 6, such that concrete of a desired slump flow is then poured into the assembled moulds so as to locate the concrete on top of the previously cast building element 6 and so as to bring the concrete into contact with the casting surfaces 14 of the mould-halves. The concrete will then form a coherent bond with the previously cast building element 6 so as to extend the building element.

The optional steps will now be explained hereinbelow.

Depending on the application, it may be desirable to include in the construction element 6 one or more conduits, such as, for example, the conduit 8 configured for receiving one or more cables such as, for example, electrical power cables, telephone cables, data carrying cables and the like.

It will be appreciated that due to the relatively non-linear shape of the construction element 6, standard conventional conduits may not be suitable for imbedding within the construction element 6. More specifically, it will be appreciated that even though known conduits are flexible and able to bend, such conduits will certainly not be able to follow the twisted profile of the construction element 6 and it will most certainly not be possible for conventional conduits to be located relatively centrally with respect to the construction element 6.

In order to facilitate the provision of a conduit within the construction element 6, the inventors have found that it is advantageous to produce, in a sixth step 130, a conduit 18 from a plastics material using an additive manufacturing technique such as, for example, 3D printing.

More particularly, the inventors have found that it is particularly, advantageous to provide the conduit 18 with a profile which matches a profile of the construction element 6. Once the conduits 18 are printed, cables are located within the conduits 18 in accordance with known methods. More specifically, the cables are passed through the conduits before the conduits are installed in the desired position within the mould halves. Also, the conduits are designed such that it is easy to place the cables. The conduits do not necessarily have to follow the shape of the external concrete structure as long as the conduit shape allows it to be embedded in the concrete.

The inventors have further found that to overcome the problem of locating the conduit 18 with respect to the mould bodies 12 and with respect to the construction element 6, it is particularly, advantageous in the third step 124, to provide the locating formation 16 on a particular one of the mould-halves 12.7. As such, in an eight step 134, the locating formation 16 positively locates the conduit 18 relative to the mould-half 12.7 and thereby locates the conduit 18 relative to the construction element 6. As illustrated in FIGS. 6A & 6B of the drawings, the locating formation 16 of the mould-half 12.7 locates the conduit 16 centrally with respect to the mould 10, such that the conduit 16 will be centrally located with respect to the construction element 6 and surrounded and embedded in the construction element 6.

The inventors have advantageously found that the method 100 is advantageous as it allows complex and intricate construction elements to be formed. These complex structures can further advantageously include imbedded conduits.

The inventors have advantageously found that the mould-halves are rendered re-usable due to the fact that the mould-halves are printed using a 3D printing technique including an adhesive dispensing system in conjunction with the polyurea based compound or polyurethane coating. More specifically, the inventors have surprising found that because the mould-halves are printed using a 3D printing technique including an adhesive dispensing system in combination with the polyurea based compound or polyurethane coating, the toughness of the mould-halves are increased by approximately 300% when compared to moulds produced by other known methods of additive manufacturing.

It must be understood that the sequence of the steps in the method 100 described hereinabove are for explanation purposes only. Clearly, the sequence of the steps can be changed where applicable and depending on the circumstances.

The invention extends also to a construction element formed by the method and/or the mould as described and defined hereinabove. The invention extends further to a building structure including the construction element formed by the method and/or the mould as described and defined hereinabove.

Specific examples of systems, methods and apparatus have been described herein for purposes of illustration. These are only examples. The technology provided herein can be applied to systems other than the example systems described above. Many alterations, modifications, additions, omissions and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

It is therefore intended that the following appended claims and claims hereafter introduced are interpreted to include all such modifications, permutations, additions, omissions and sub-combinations as may reasonably be inferred. The scope of the claims should not be limited by the preferred embodiments set forth in the examples but should be given the broadest interpretation consistent with the description.

What is claimed is:

1. A method for casting a construction element, the method including:
using, at least in part, an additive manufacturing technique to fabricate at least one mould comprising a negative of a construction element to be cast, the at least one mould including one or more casting surfaces;
reinforcing, at least in part, said at least one mould with a polymeric material;
pouring a settable material in contact with said one or more casting surfaces of the at least one mould;
at least partially curing the poured settable material so as to form the construction element.

2. The method for casting a construction element as claimed in claim 1, wherein reinforcing, at least in part, said at least one mould comprises coating the at least one mould with the polymeric material.

3. The method for casting a construction element as claimed in claim 1, wherein the method further includes using, at least in part, an additive manufacturing technique to fabricate at least one conduit.

4. The method for casting a construction element as claimed in claim 3, wherein the method further includes locating the at least one conduit relative to said at least one mould, prior to pouring the settable material.

5. The method for casting a construction element as claimed in claim 4, wherein the method further includes providing the mould with a locating formation for locating the at least one conduit relative to the mould and thereby locating the at least one conduit relative to the construction element.

6. The method for casting a construction element as claimed in claim 3, wherein the at least one conduit is configured for receiving one or more cables.

7. The method for casting a construction element as claimed in claim 3, wherein said at least one conduit has a profile which matches a profile of the construction element.

8. The method for casting a construction element as claimed in claim 5, wherein the at least one conduit is located relative to the mould such that the conduit is at least partially surrounded by the construction element once the construction element is formed.

9. The method for casting a construction element as claimed in claim 5, wherein the at least one conduit is embedded in the construction element.

10. The method for casting a construction element as claimed in claim 1, wherein the method further includes removing the at least one mould after forming the construction element.

11. The method for casting a construction element as claimed in claim 1, wherein the additive manufacturing technique is in the form of a three-dimensional (3D) printing technique.

12. The method for casting a construction element as claimed in claim 11, wherein the 3D printing technique includes an adhesive dispensing system for dispensing adhesive onto an article being printed, for enhancing the strength and rigidity of the article being printed.

13. The method for casting a construction element as claimed in claim 12, wherein said at least one mould is rendered re-usable due to the combination of the following steps:
printing said at least one mould using the 3D printing technique including an adhesive dispensing system; and
reinforcing, at least in part, said at least one mould with a polymeric material.

14. The method for casting a construction element as claimed in claim 3, wherein the additive manufacturing technique used to fabricate said at least one conduit is in the form of a three-dimensional (3D) printing technique.

15. The method for casting, a construction element as claimed in claim 14, wherein the 3D printing technique used to fabricate said at least one conduit includes an adhesive dispensing system for dispensing adhesive onto the article being printed for enhancing the strength and rigidity of the article being printed.

16. The method for casting a construction element as claimed in claim 1, wherein the at least one mould comprises one or more pairs of complementary mould-parts.

17. The method for casting a construction element as claimed in claim 16, wherein each pair of complementary mould-parts are in the form of a pair of mould-halves.

18. The method for casting a construction element as claimed in claim 17, wherein the method further includes securing the mould-halves to one another.

19. A construction element formed by the method as claimed in claim 1.

20. A building structure including the construction element as claimed in claim 19.
